(19) United States
(12) Patent Application Publication
(10) Pub. No.: US 2025/0243968 A1
(43) Pub. Date: Jul. 31, 2025

(54) Support Leg and Support Stand with Rotary Locking Mechanism

(71) Applicant: Zhongshan Jingge Electronic Technology Co., Ltd., Zhongshan City (CN)

(72) Inventors: Lichun Huang, Hunan (CN); Zihan Huang, Zhongshan (CN); Wenjia Tang, Zhejiang (CN)

(21) Appl. No.: 18/422,315

(22) Filed: Jan. 25, 2024

(51) Int. Cl. F16M 11/32

(52) U.S. Cl. CPC F16M 11/32; F16M 2200/025

(57) ABSTRACT

The present invention discloses a support leg and a support stand with a rotary locking mechanism. The support leg comprises multiple telescopic tubes and multiple rotary locking components. The multiple telescopic tubes are sequentially nested; and the multiple rotary locking components are connected between the adjacent telescopic tubes. The rotary locking components can be successively unlocked from top to bottom when the last telescopic tube is reverse-rotated, allowing the multiple telescopic tubes to expand or retract; or the rotary locking components can be successively locked from bottom to top when the last telescopic tube is forward-rotated, maintaining the multiple telescopic tubes in an expanded or retracted state. The structure described above enables rapid expansion and retraction of the support leg by rotating the last telescopic tube, thereby enhancing convenience of use.

### FIELD OF INVENTION

The present invention relates to the field of photographic equipment, in particular to a support leg and a support stand with a rotary locking mechanism.

### BACKGROUND OF THE PRESENT INVENTION

Cell phones and cameras (or tablets, laptops, etc.) are commonly used devices in people's daily lives and work. In order to facilitate the user's needs in photography, a support stand is often used to support the photographic equipment, thereby freeing the user's hands. The support stand typically includes multiple support legs, and the support legs are extendable to adjust the height of the frame. Conventional extendable legs have three segments with a set of locking mechanisms between adjacent segments. Each set of locking mechanisms has independent lock/unlock switches. To unfold the entire support stand, all six lock/unlock switches must be opened, making it inconvenient to use. Therefore, there is a need for a support leg and a support stand with a rotary locking mechanism to address these issues.

### SUMMARY OF THE PRESENT INVENTION

The present invention aims to solve at least one technical problem in the prior art. To achieve this, the present invention provides a support leg and a support stand with a rotary locking mechanism.

An embodiment of the present invention to solve the technical problem adopts the following technical solution: a support leg with a rotary locking mechanism, comprising multiple telescopic tubes and multiple rotary locking components; wherein:
the multiple telescopic tubes are sequentially nested; and
the multiple rotary locking components are connected between the adjacent telescopic tubes.

The rotary locking components can be successively unlocked from top to bottom when the last telescopic tube is reverse-rotated, allowing the multiple telescopic tubes to expand or retract. Alternatively, the rotary locking components can be successively locked from bottom to top when the last telescopic tube is forward-rotated, maintaining the multiple telescopic tubes in an expanded or retracted state.

In a preferred embodiment of the present invention, the rotary locking components include a first synchronous ring, a second synchronous ring, and a locking sleeve.

The first synchronous ring is sleeved on the first telescopic tube and rotates synchronously, with a first inclined surface on the inner sidewall at one end.

The second synchronous ring is sleeved on the second telescopic tube and rotates synchronously, with a second inclined surface on the outer sidewall at one end abutting the first inclined surface.

The locking sleeve is connected at one end to the second synchronous ring and rotates synchronously. The other end is connected to the first synchronous ring through a first threaded connection structure.

The locking sleeve can drive the second synchronous ring toward the first synchronous ring when the second telescopic tube is forward-rotated and press against the second telescopic tube to limit the rotation between the first telescopic tube and the second telescopic tube. Alternatively, the locking sleeve can drive the second synchronous ring backward from the first synchronous ring when the second telescopic tube is reverse-rotated and loosen the second telescopic tube to allow the second telescopic tube to expand or retract relative to the first telescopic tube.

In a preferred embodiment of the present invention, a first limiting component is provided between the first synchronous ring and the other end of the locking sleeve to limit the relative displacement between the first synchronous ring and the locking sleeve.

In a preferred embodiment of the present invention, the first limiting component comprises a limiting sleeve and a first annular limiting block provided on the outer sidewall of the first synchronous ring. The limiting sleeve is connected to the inner sidewall of the locking sleeve through a second threaded connection structure and abuts against the first annular limiting block.

In a preferred embodiment of the present invention, the second synchronous ring is connected to one end of the locking sleeve through a second limiting component to limit the relative displacement between the second synchronous ring and the locking sleeve.

In a preferred embodiment of the present invention, the second limiting component comprises a circular limiting groove formed on the second synchronous ring and a second annular limiting block provided on the locking sleeve. The second annular limiting block is inserted into the circular limiting groove.

In a preferred embodiment of the present invention, the inner sidewall of the other end of the first synchronous ring is provided with an abutting sleeve, and the first inclined surface is formed on the inner sidewall of the abutting sleeve.

In a preferred embodiment of the present invention, the sidewall of the second synchronous ring is provided with multiple axially penetrating and longitudinally extending dividing grooves.

In a preferred embodiment of the present invention, the cross-sectional outline of the telescopic tube is non-circular.

A support stand comprises the aforementioned support leg.

Advantages of the present invention: In the support leg and the support stand with the rotary locking mechanism, the support leg comprises the multiple telescopic tubes and the multiple rotary locking components; the multiple telescopic tubes are sequentially nested; and the multiple rotary locking components are connected between the adjacent telescopic tubes. The rotary locking components can be successively unlocked from top to bottom when the last telescopic tube is reverse-rotated, thereby allowing the multiple telescopic tubes to expand or retract; or the rotary locking components can be successively locked from bottom to top when the last telescopic tube is forward-rotated, thereby maintaining the multiple telescopic tubes in the expanded or retracted state. The structure described above enables rapid expansion and retraction of the support leg by rotating the last telescopic tube, thereby enhancing convenience of use.

### BRIEF DESCRIPTION OF THE DRAWINGS

The foregoing and/or additional aspects and advantages of the present invention will be apparent and readily understood from the following description of the embodiments in conjunction with the accompanying drawings, wherein:

FIG. 1 is a schematic diagram of the structure of a support stand in a retracted state;

FIG. 2 is an exploded view of a support leg with a rotary locking mechanism in an expanded state;

FIG. 3 is a partially enlarged view of area A in FIG. 2;

FIG. 4 is a sectional view of a support leg with a rotary locking mechanism in a retracted state; and

FIG. 5 is a partially enlarged view of area B in FIG. 4.

### DETAILED DESCRIPTION OF THE PREFERRED EMBODIMENTS

In this section, specific embodiments of the present invention will be described in detail. The preferred embodiments of the present invention are shown in the accompanying drawings, which serve to supplement the textual description of the specification with drawings to provide a visual and illustrative understanding of each technical feature and the overall technical scheme of the present invention. However, it should not be construed as a limitation on the scope of protection of the present invention.

As used in the specification of the present invention, the term “multiple” means two or more. Terms such as “greater than”, “less than”, “exceed”, etc., should be understood to exclude the number itself, while terms such as “above”, “below”, “within”, etc., should be understood to include the number itself. The terms “first”, “second”, etc., are used only to distinguish technical features and should not be construed as indicating or implying relative importance or as implying the number or order of technical features referred to.

In the description of the present invention, it should be understood that terms relating to orientation, such as “up”, “down”, “front”, “back”, “left”, “right”, etc., are based on the orientation or positional relationships shown in the drawings. These are only for convenience in describing the present invention and simplifying the description, and do not indicate or imply that the device or element referred to must have a particular orientation, be constructed and operated in a particular orientation, and should therefore not be considered as a limitation of the present invention.

In the present invention, unless otherwise expressly limited, terms such as “provided”, “mounted”, and “connected” should be understood broadly. For instance, they could mean directly connected or indirectly connected through an intermediary; they could mean permanently connected or detachably connected; they could mean integrally formed; they could mean mechanically connected; they could mean internal communication or interaction between two elements. Those skilled in the relevant art will be able to determine the specific meanings of these terms in the present invention through the context of the specific technical scheme

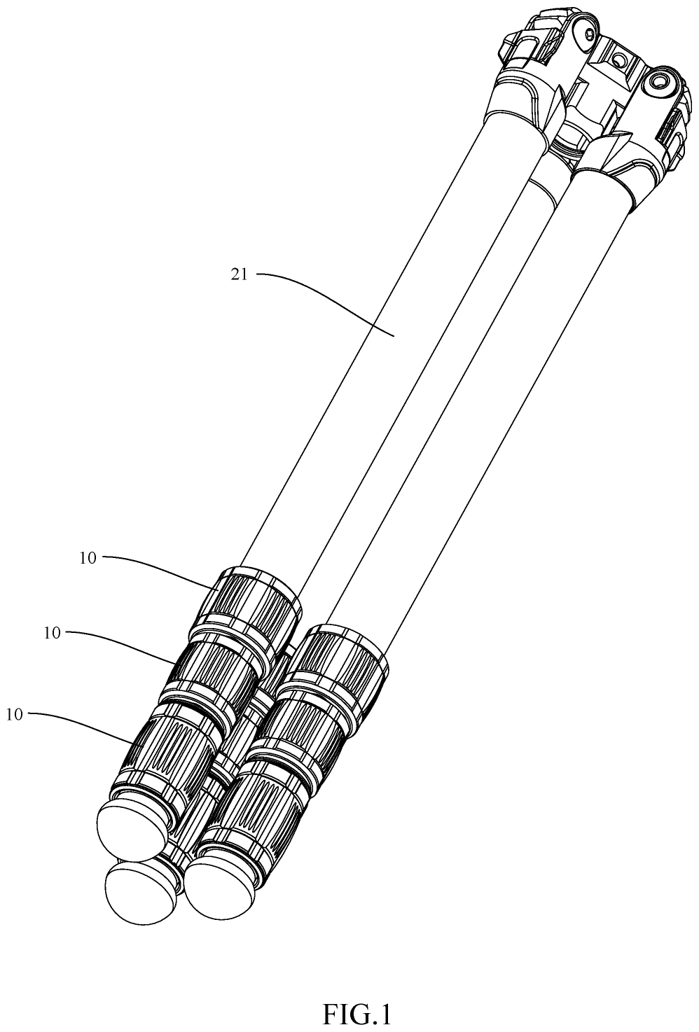

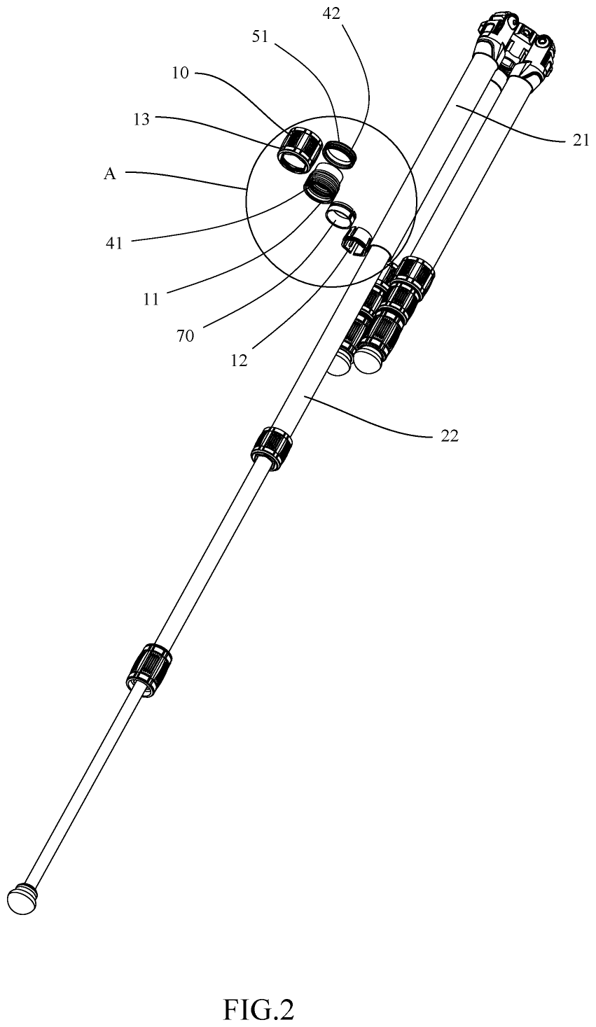

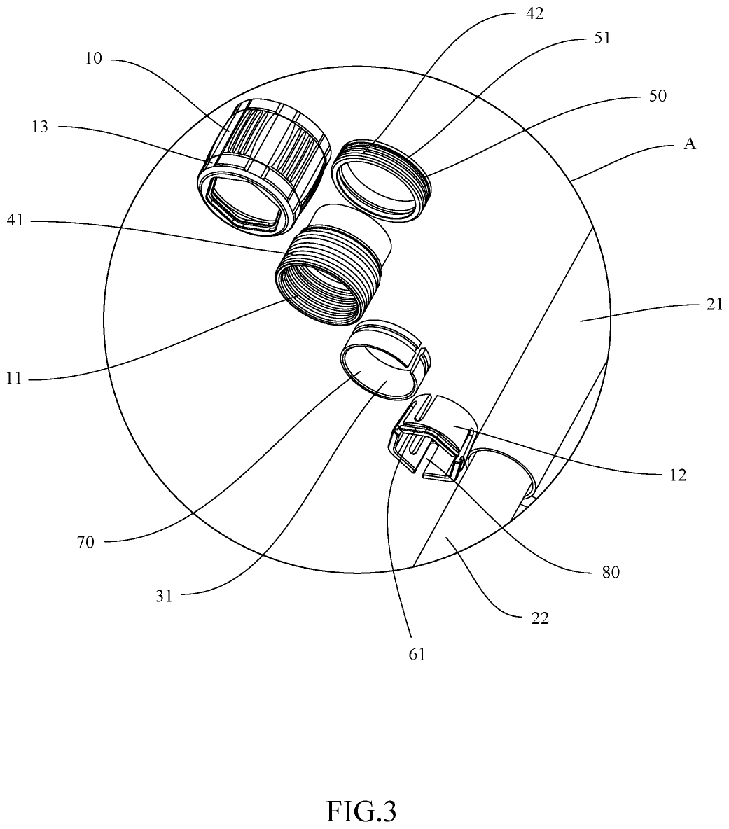

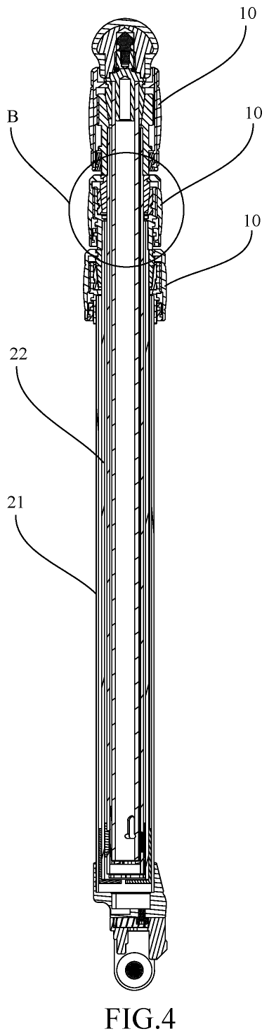

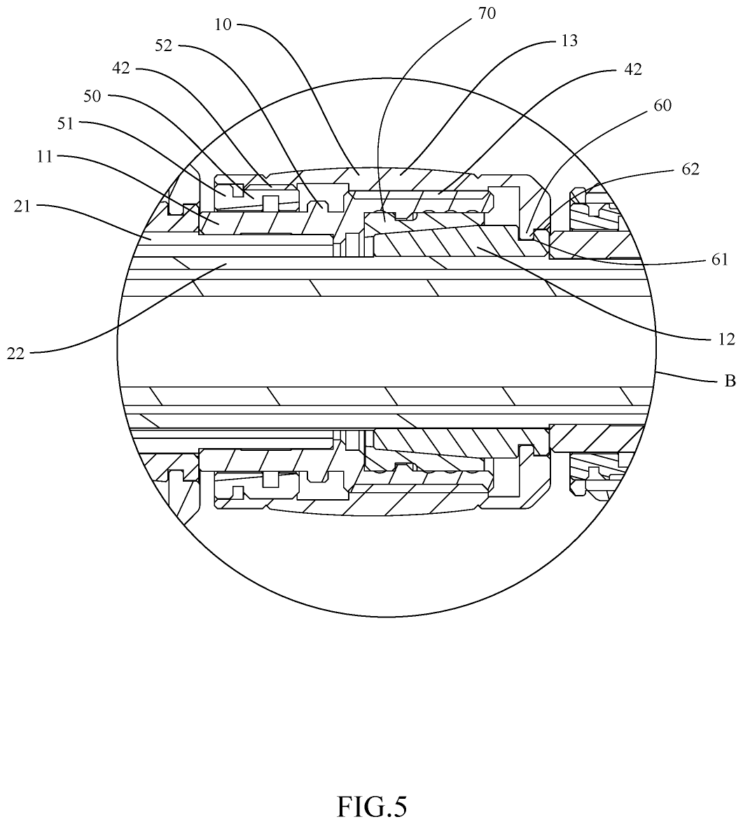

Referring to FIGS. 1 to 5, a support leg with a rotary locking mechanism comprises multiple telescopic tubes and multiple rotary locking components 10; wherein:
the multiple telescopic tubes are sequentially nested; and
the multiple rotary locking components 10 are connected between the adjacent telescopic tubes.

The rotary locking components 10 can be successively unlocked from top to bottom when the last telescopic tube is reverse-rotated, thereby allowing the multiple telescopic tubes to expand or retract. Alternatively, the rotary locking components 10 can be successively locked from bottom to top when the last telescopic tube is forward-rotated, thereby maintaining the multiple telescopic tubes in an expanded or retracted state.

\textcircled{1} In the present invention, the transformation of the support leg from the retracted state to the expanded state is taken as an example for illustration. In use, a last telescopic tube (a second telescopic tube 22) is rotated in the reverse direction. This action causes a locking sleeve 13 and a second synchronous ring 12 to rotate, and since the locking sleeve 13 is threaded with a first synchronous ring 11, the second synchronous ring 12 moves backward relative to the first synchronous ring 11. Under the action of a first inclined surface 31 and a second inclined surface 32, the abutment with the second telescopic tube 22 is released to allow the second telescopic tube 22 to expand relative to a first telescopic tube 21, i.e., to convert the locking state of the rotary locking components 10 from locked to unlocked. Since the first telescopic tube 21 serves as a previous level of the second telescopic tube 22, this action thus drives the previous level rotary locking components 10 through the same motion process so that the upper-level rotary locking components 10 are sequentially unlocked from top to bottom, and finally the expansion of the multiple telescopic tubes is achieved simultaneously.

\textcircled{2} When the telescopic tubes are fully expanded or fully retracted, the last telescopic tube (the second telescopic tube 22) is rotated in the forward direction. This action causes the locking sleeve 13 and the second synchronous ring 12 to rotate, and since the locking sleeve 13 is threaded with the first synchronous ring 11, the second synchronous ring 12 moves toward the first synchronous ring 11. Under the action of the first inclined surface 31 and the second inclined surface 32, the second telescopic tube 22 is pressed tightly to limit the relative rotation between the first telescopic tube 21 and the second telescopic tube 22, i.e., to convert the locking state of the rotary locking components 10 from unlocked to locked. Since the first telescopic tube 21 serves as a previous level of the second telescopic tube 22, this action thus drives the previous level rotary locking components 10 through the same motion process so that the upper-level rotary locking components 10 are sequentially locked from top to bottom, and finally the expansion or retraction of the multiple telescopic tubes is maintained.

\textcircled{3} The advantages of the present invention are as follows: The above structure allows the multiple telescopic tubes to be unlocked or locked successively from the bottom to the top by rotating the last telescopic tube, allowing the multiple telescopic tubes to expand or retract synchronously to achieve the rapid expansion and retraction of the support leg, thereby enhancing the convenience of use.

In a preferred embodiment of the rotary locking components 10, comprising the first synchronous ring 11, the second synchronous ring 12, and the locking sleeve 13.

The first synchronous ring 11 is sleeved on the first telescopic tube 21 and rotates synchronously, with the first inclined surface 31 on the inner sidewall at one end.

The second synchronous ring 12 is sleeved on the second telescopic tube 22 and rotates synchronously, with the second inclined surface 32 on the outer sidewall at one end abutting the first inclined surface 31.

One end of the locking sleeve 13 is connected to the second synchronous ring 12 and rotates synchronously, and the other end is connected to the first synchronous ring 11 through a first threaded connection structure 41.

The locking sleeve 13 can drive the second synchronous ring 12 toward the first synchronous ring 11 when the second telescopic tube 22 is forward-rotated and press against the second telescopic tube 22 to limit the rotation between the first telescopic tube 21 and the second telescopic tube 22. Alternatively, the locking sleeve 13 can drive the second synchronous ring 12 backward from the first synchronous ring 11 when the second telescopic tube 22 is reverse-rotated and loosen the second telescopic tube 22 to allow the second telescopic tube 22 to expand or retract relative to the first telescopic tube 21.

In a preferred embodiment of the rotary locking components 10, a first limiting component 50 is provided between the first synchronous ring 11 and the other end of the locking sleeve 13 to limit the relative displacement between the first synchronous ring 11 and the locking sleeve 13.

In a preferred embodiment of the first limiting component 50, comprising a limiting sleeve 51 and a first annular limiting block 52 provided on the outer sidewall of the first synchronous ring 11. The limiting sleeve 51 is connected to the inner sidewall of the locking sleeve 13 through a second threaded connection structure 42 and abuts against the first annular limiting block 52. In other words, the locking sleeve 13 can drive the limiting sleeve 51 to rotate together until the limiting sleeve 51 abuts against the first annular limiting block 52, preventing the locking sleeve 13 from exceeding the range of motion and causing detachment.

In a preferred embodiment of the rotary locking components 10, the second synchronous ring 12 is connected to one end of the locking sleeve 13 through a second limiting component 60 to limit the relative displacement between the second synchronous ring 12 and the locking sleeve 13.

In a preferred embodiment of the second limiting component 60, comprising a circular limiting groove 61 formed on the second synchronous ring 12 and a second annular limiting block 62 provided on the locking sleeve 13. The second annular limiting block 62 is inserted into the circular limiting groove 61. Since the locking sleeve 13, the second synchronous ring 12, and the second telescopic tube 22 are all non-circular tubes, the three will rotate synchronously. However, the locking sleeve 13 and the second synchronous ring 12 will perform a linear motion along the length of the telescopic tube, thereby tightening or loosening the second telescopic tube 22 under the action of the first synchronous ring 11.

In a preferred embodiment of the first synchronous ring 11, the inner sidewall of the other end of the first synchronous ring 11 is provided with an abutting sleeve 70, and the first inclined surface 31 is formed on the inner sidewall of the abutting sleeve 70. The abutting sleeve 70 is made of a material with a lower friction coefficient, which is capable of improving the smooth rotation of the telescopic tube.

In a preferred embodiment of the second synchronous ring 12, the sidewall of the second synchronous ring 12 is provided with multiple axially penetrating and longitudinally extending dividing grooves 80. This configuration allows the second synchronous ring 12 to partially deform, thereby facilitating better deformation and abutment of the second telescopic tube 22 under the influence of the first synchronous ring 11.

In a preferred embodiment of the telescopic tube, the cross-sectional outline of the telescopic tube is configured as non-circular, preferably as a regular hexagon with chamfered edges, which serves the purpose of synchronized rotation and provides limiting effects.

A support stand comprises the aforementioned support leg.

Of course, the present invention is not limited to the above embodiments. Those skilled in the art may make equivalent modifications or substitutions without departing from the spirit of the present invention, and such equivalent modifications and substitutions are included within the scope defined by the claims of this application

What is claimed is:

1. A support leg with a rotary locking mechanism, comprising:
multiple telescopic tubes sequentially nested one within another; and
multiple rotary locking components (10), each configured to be operatively coupled between adjacent telescopic tubes;
wherein the rotary locking components (10) are mechanically linked such that a rotation of the last telescopic tube in a reverse direction of the last telescopic tube causes sequential unlocking of the rotary locking components (10) from top to bottom,
allowing the multiple telescopic tubes to expand or retract; or wherein a forward rotation of the last telescopic tube causes stepwise locking of the rotary locking components (10) from bottom to top, thereby securing the telescopic tubes in position, such that a single rotation input at the last telescopic tube enables coordinated locking or unlocking of all rotary locking components (10).

2. The support leg according to claim 1, wherein the rotary locking components (10) comprises:
a first synchronous ring (11) disposed around a first telescopic tube (21), the first synchronous ring (11) being fixed to rotate with the first telescopic tube (21) and having a first inclined surface (31) on an inner sidewall at one end;
a second synchronous ring (12) disposed around a second telescopic tube (22), the second synchronous ring (12) being fixed to rotate with the second telescopic tube (22) and having a second inclined surface (32) on an outer sidewall at one end, the second inclined surface (32) being positioned to abut the first inclined surface (31); and
a locking sleeve (13) having a first end coupled to the second synchronous ring (12) and a second end coupled to the first synchronous ring (11) via a first threaded connection structure (41), the locking sleeve (13) being configured such that forward rotation of the second telescopic tube (22) causes the second synchronous ring (12) to move toward the first synchronous ring (11), thereby generating a pressing force that restricts relative rotation between the first and second telescopic tubes (21, 22), and reverse rotation of the second telescopic tube (22) causes the second synchronous ring (12) to move away from the first synchronous ring (11), thereby reducing the pressing force and allowing relative movement between the telescopic tubes.

3. The support leg according to claim 2, wherein a first limiting component (50) is provided between the first synchronous ring (11) and the other end of the locking sleeve (13) to limit the relative displacement between the first synchronous ring (11) and the locking sleeve (13).

4. The support leg according to claim 3, wherein the first limiting component (50) comprises a limiting sleeve (51) and a first annular limiting block (52) provided on the outer sidewall of the first synchronous ring (11), the limiting sleeve (51) being connected to the inner sidewall of the locking sleeve (13) through a second threaded connection structure (42) and abutting against the first annular limiting block (52).

5. The support leg according to claim 2, wherein the second synchronous ring (12) is connected to one end of the locking sleeve (13) through a second limiting component (60) to limit the relative displacement between the second synchronous ring (12) and the locking sleeve (13).

6. The support leg according to claim 5, wherein the second limiting component (60) comprises a circular limiting groove (61) formed on the second synchronous ring (12) and a second annular limiting block (62) provided on the locking sleeve (13), wherein the second annular limiting block (62) is inserted into the circular limiting groove (61).

7. The support leg according to claim 1, wherein the inner sidewall of the other end of the first synchronous ring (11) is provided with an abutting sleeve (70), and the first inclined surface (31) is formed on the inner sidewall of the abutting sleeve.

8. The support leg according to claim 2, wherein the sidewall of the second synchronous ring (12) is provided with multiple axially penetrating and longitudinally extending dividing grooves (80).

9. The support leg according to claim 1, wherein the cross-sectional outline of the telescopic tube is non-circular.

10. A support stand comprising the support leg according to claim 1.
